(19) United States
(12) Patent Application Publication
(10) Pub. No.: US 2008/0017009 A1
(43) Pub. Date: Jan. 24, 2008

(54) Reversible circular saw blade

(76) Inventor: David D. Setliff, Cool Ridge, WV (US)

Correspondence Address: LITMAN LAW OFFICES, LTD., P.O. BOX 15035, CRYSTAL CITY STATION, ARLINGTON, VA, 22215, US

(21) Appl. No.: 11/892,508

(22) Filed: Aug. 23, 2007

Related U.S. Application Data
(63) Continuation-in-part of application No. 11/034,741, filed on Jan. 14, 2005, now abandoned.
(60) Provisional application No. 60/543,932, filed on Feb. 13, 2004.

(51) Int. Cl. B27B 33/08

(52) U.S. Cl. 83/848

(57) ABSTRACT

The reversible circular saw blade has a plurality of saw teeth, each tooth having a forward-facing cutting edge and a trailing cutting edge so that the saw blade can be removed and reattached to the circular saw with the opposite face of the blade abutting the saw in order to cut with the trailing cutting edge when the forward cutting edge becomes dull. A top surface extends from the forward-facing cutting edge to the trailing cutting edge. The top surface of each tooth has a radius of curvature at least equal to the radius of the saw blade.

### CROSS-REFERENCE TO RELATED APPLICATION

This application is a continuation-in-part application of U.S. patent application Ser. No. 11/034,741, filed on Jan. 14, 2005, which claimed the benefit of U.S. Provisional Patent Application Ser. No. 60/543,932, filed on Feb. 13, 2004.

### BACKGROUND OF THE INVENTION

1. Field of the Invention

The present invention relates to circular saw blades, and in particular, to a saw blade having a particular tooth configuration that allows the blade to be reversed when dulled on one side.

2. Description of the Related Art

Circular saw blades are subject to wear, requiring periodic sharpening and eventual replacement. The maintenance of circular saw blades may be reduced by removing the blade from the saw and flipping it over so as to reverse the saw during cutting. Circular saw blade designs exist which are reversible; however, their designs, and particularly the designs of the reversible teeth, are complex and expensive to produce, particularly those with hardened tooth inserts such as tungsten-carbide. It would be desirable to provide a reversible circular saw, which is simple in design and requires minimal machining of teeth, particularly those having hardened inserts such as tungsten-carbide tips.

Thus, a reversible circular saw blade solving the aforementioned problems is desired.

### SUMMARY OF THE INVENTION

The reversible circular saw blade of the present invention has a disk-shaped body having a plurality of saw teeth mounted around its periphery, each tooth having a forward-facing cutting edge and a trailing cutting edge. A top surface extends from the forward-facing cutting edge to the trailing cutting edge. The tooth's top surface is convex in relation to the central axis of the circular blade, having a center of curvature at a distance at least equal to the overall radius of the saw blade. The saw blade is for cutting wood or other materials of similar hardness and is reversible such that the blade, when dull in one direction, can be removed from the saw, flipped over, and mounted and used as though new.

It is an aspect of the invention to provide improved elements and arrangements thereof for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is perspective view of a reversible circular saw blade according to the present invention.

FIG. 2 is a side elevation detail of a representative tooth of the saw blade of FIG. 1.

FIG. 3 is an end view showing the front cutting edge of a representative tooth of the saw blade of FIG. 1.

FIG. 4 is a side view of an alternative embodiment of a reversible circular saw blade according to the present invention.

FIG. 5 is a partial, detail side view of a representative tooth of the saw blade of FIG. 4.

Similar reference characters denote corresponding features consistently throughout the attached drawings.

### DETAILED DESCRIPTION OF THE PREFERRED EMBODIMENT

The present invention is a reversible spindle-mounted circular saw blade for circular saws.

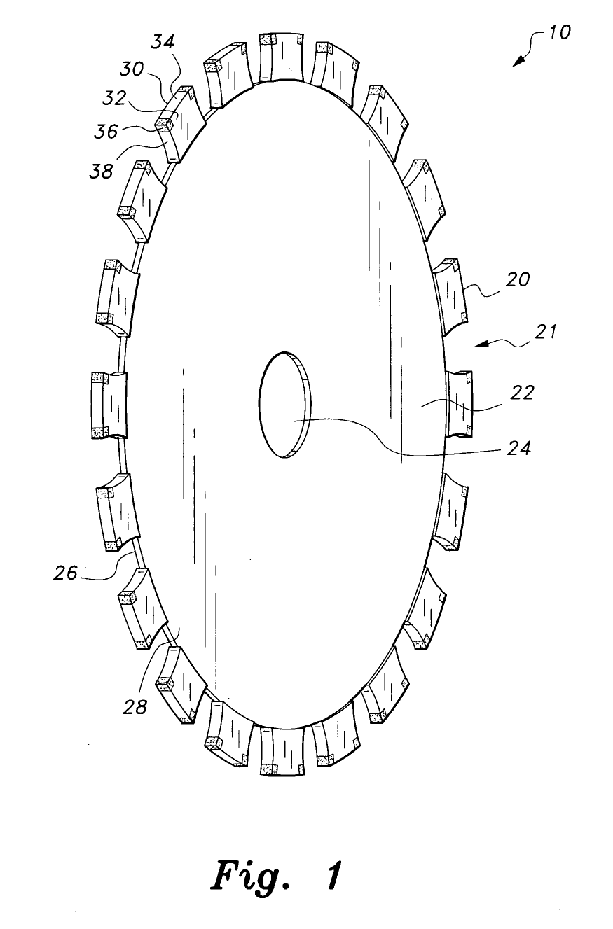

Referring to FIG. 1, there is shown a circular saw blade 10 having a number of identical teeth 20 spaced around its circumference 26. Circular saw blade 10 includes a disc-shaped body 22 having a centrally located mounting hole 24 for mounting the blade 10 on the spindle of a circular saw. Body 22 has a first side 26 and a second side 28. Saw teeth 20, having gullets 21 therebetween, are disposed about the circumference of disc-shaped body 22.

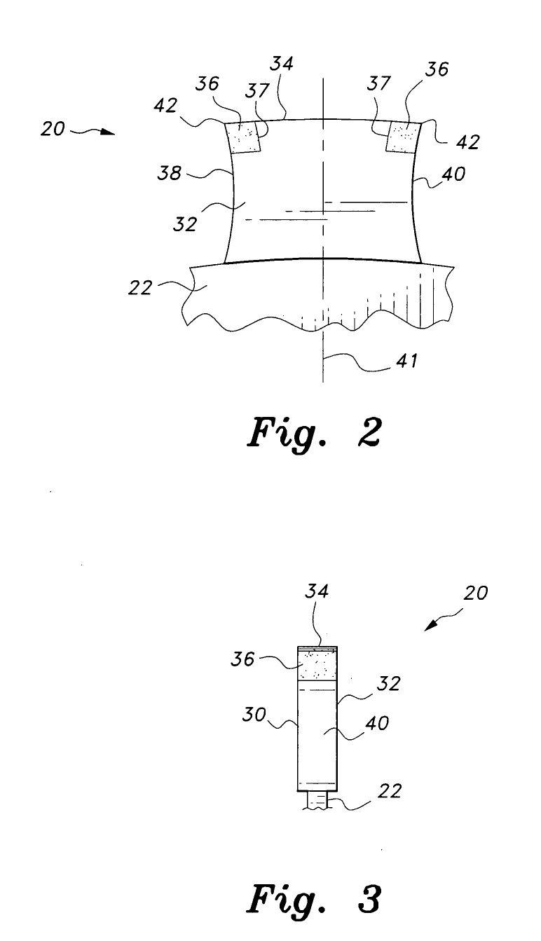

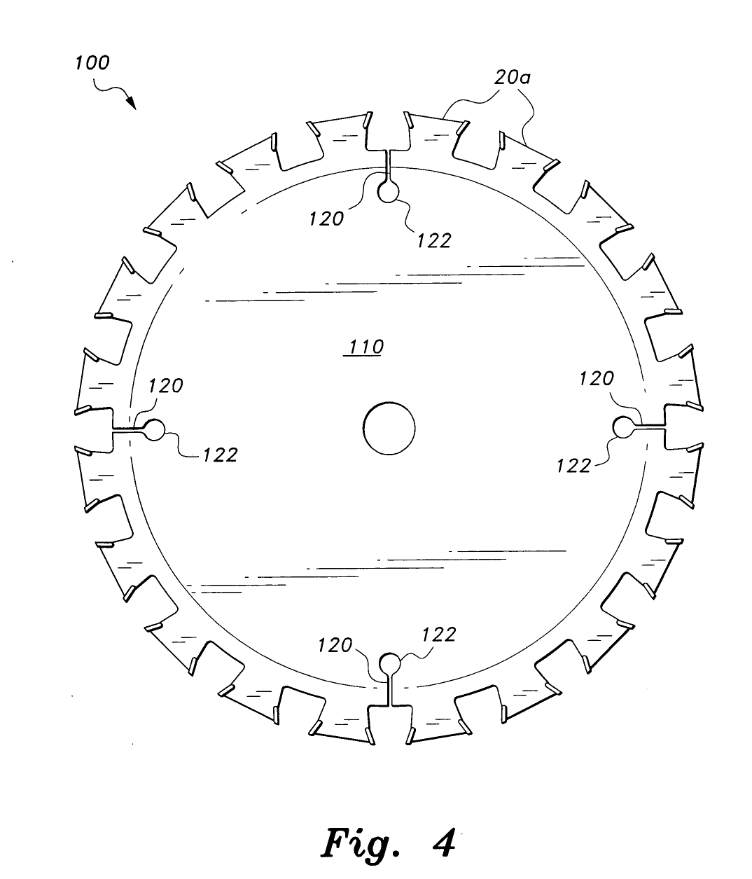

Referring now to FIGS. 2 and 3, the structure of each saw tooth 20 will be described in greater detail. Each saw tooth 20 has a first side 30 (FIGS. 1, 3), an opposite side 32, a top face 34, a front cutting edge 40, and a trailing or back cutting edge 38. Saw teeth 20 made of steel or steel alloy or other appropriate material may be employed in this configuration. The overall structure including the body and the teeth may be a unitary structure, or the teeth may be joined to the body by welding, brazing, or the like. However, it is preferred that tips of a hard material such as tungsten-carbide be added to the teeth. To add these tips a pair of notches 37 is formed in each tooth 20 where the top face meets the front edge 40 and the back edge 38, respectively. In each notch, a tip insert 36 of hard material, e.g., tungsten-carbide, is brazed or otherwise fixed. Top face 34 is forms a convex curve with relation to the central axis of the saw blade with a center of curvature of a length of at least the overall radius of the saw blade, i.e., the top face 34 has a radius of curvature equal to or greater than the radius of the blade 10.

Each tooth 20 is symmetrical about a respective radial centerline 41 and is slightly wider than disc portion 22 to reduce binding, friction, and heat generated between disc portion 22 and the workpiece. Front edge 40 and back edge 38 are concave to provide a sharpened point 42 at the location of tips 36. A gullet 21 is provided between adjacent teeth, as shown in FIG. 1. When reversed, edge 38 becomes the front cutting edge and edge 40 becomes the trailing edge.

Representative dimensions of the saw blade are provided as follows, it being understood that the scope of the present invention is not limited to the dimensions recited, but encompasses saw blades of different diameter, the dimensions specified below being provided for illustration purposes. A representative saw blade 10 is about 7¼″ (18 cm) in diameter. Disc portion 22 is 1/16″ (2 mm) thick and each tooth is about ⅛″ (4 mm) thick. Each tooth 20 has a height of about 7/16″ (1.1 cm) from the outer circumference 26 of disc portion 22 to top face 34 of tooth 20. Each tooth has a length of about ⅝″ (1.6 cm) from the point 42 at the front edge 40 to the opposing point 42 at the back edge 38 and are equally spaced about ½″ (1.3 cm) apart from each other. Each carbide tip 36 is about 3/32″ (2 mm) in both height and length, and is at least as wide as tooth 20. It should be noted that these dimensions are exemplary only and that other dimensions are possible without departing from the spirit of the invention.

While blade 10, as described above, has a diameter of about 7¼″ (18 cm), other diameter blades are possible. The present invention may be particularly suited to large diameter blades up to about 30″ (76 cm) or more in diameter. In addition, teeth 20 may be spaced as shown or may be spaced farther apart or closer together. The tooth height and length may be chosen for differing diameter blades and for fineness of cut. Although described with tungsten-carbide tips the inventive blade may be provided without tip inserts of this type. The blade 10 and teeth 20 may be made of any appropriate metal or metal alloy such as steel. The blade 10 and teeth 20 are preferably unitary in construction but teeth 20 may be separately applied to the circumference 26 of the blade 10.

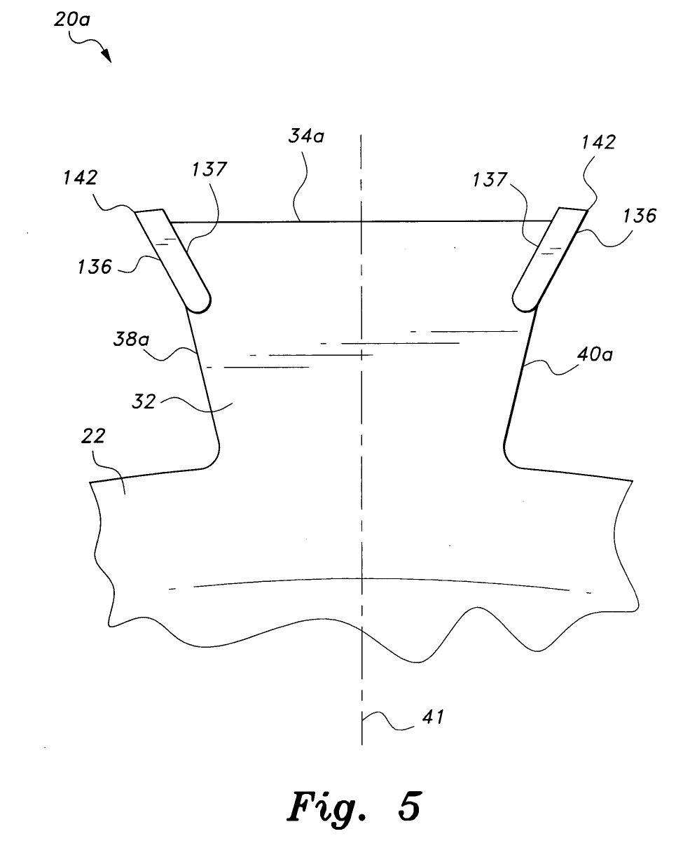

In the alternative embodiment of FIGS. 4 and 5, saw blade 100 includes a substantially circular main body portion 110, having a plurality of teeth 20 formed thereon, similar to that described above with regard to the embodiment of FIGS. 1-3. However, as shown in FIG. 4, a plurality of expansion slots 120 are formed in the main body portion 110. Preferably, each expansion slot projects along a substantially radial direction, as shown, although it should be understood that the expansion slots 120 may be oriented in any other suitable direction. Further, although shown as having four equally spaced slots 120 in FIG. 4, it should be understood that any suitable number of expansion slots 120 may be provided.

Preferably, each expansion slot 120 is provided with a lower, round stress dispersion hole 122 in order to alleviate stresses and prevent cracks in blade 100. Expansions slots 120 are provided for dissipation of mechanical stresses on the blade 100 caused by cutting, and further aid in the cooling of the blade 100.

In the embodiment of FIGS. 4 and 5, teeth 20a are substantially trapezoidal, having a linear or flat top face 34a, a rectilinear front cutting edge 40a, and a rectilinear trailing cutting edge 38a. Each tooth 20a is preferably wider than central disc 22 to prevent binding of the blade, as described above. Tip inserts 36 are replaced by inserts 136. As best shown in FIG. 5, inserts 136 are received within notches 137 and bonded to the tooth 34 by brazing or other processes for fixing the insert 136 to the tooth 34, as described above with regard to the embodiment of FIGS. 1-3. However the upper end of each insert 136 extends radially beyond the top face 34a of the tooth 20a. Each upper end of the insert 136 defines a sharpened, cutting point 142, similar to points 42 described above. Notches 137 are angled steeper than the corresponding forward cutting edge 40a or trailing cutting edge 38a so that the cutting point 142 of the tip 136 extends into the gullet 21, being angled with respect to the vertical axis of the tooth 20a, as shown.

It is to be understood that the present invention is not limited to the embodiment described above, but encompasses any and all embodiments within the scope of the following claims.

I claim:

1. A reversible circular saw blade, comprising:
a disc-shaped body having a central axis and defining a central mounting hole about the central axis for mounting the blade onto a circular saw, the disc shaped body further defining a periphery and a radius;
a plurality of teeth extending from the periphery of the body, each of the teeth defining a forward cutting edge, a trailing cutting edge, and a top face extending between the forward cutting edge and the trailing cutting edge, the plurality of teeth as mounted defining an overall radius of the circular saw blade, adjacent pairs of the teeth defining a gullet therebetween, the forward cutting edge and the trailing cutting edge each having a notch defined therein at the intersection of the top face and the respective cutting edge; and
a cutting tip insert disposed in each of the notches, the inserts being bonded to the respective tooth, each of the cutting tip inserts defining a sharpened cutting point.

2. The reversible circular saw blade as recited in claim 1, wherein said cutting tips are formed from tungsten-carbide.

3. The reversible circular saw blade as recited in claim 1, wherein said teeth have a thickness greater than that of said body and are centrally mounted relative to said body whereby said teeth extend beyond each side of said body to avoid binding and friction with the material to be cut during use.

4. The reversible circular saw blade as recited in claim 1, wherein said teeth are each symmetrical about a respective radial centerline of said body.

5. The reversible circular saw blade as recited in claim 4, wherein said teeth are equally spaced around the periphery of said body.

6. The reversible circular saw blade as recited in claim 5, wherein the height of each said tooth is approximately 1.1 cm. for an 18 cm. diameter circular saw blade.

7. The reversible circular saw blade as recited in claim 6, wherein each said tooth has a thickness of approximately 4 mm. for a 2 mm. thick circular saw blade body.

8. The reversible circular saw blade as recited in claim 1, wherein said disc shaped body has at least one expansion slot formed therein.

9. The reversible circular saw blade as recited in claim 8, wherein said at least one expansion slot extends along a substantially radial direction from the periphery of said disc-shaped body.

10. The reversible circular saw blade according to claim 1, wherein each of said teeth is substantially trapezoidal, defining a substantially flat top face, a substantially rectilinear front cutting edge, and a substantially rectilinear trailing cutting edge.

11. The reversible circular saw blade according to claim 10, wherein each said cutting tip insert has a height greater than the depth of the respective notch to which said cutting insert is bonded, whereby each said cutting tip insert extends radially beyond the corresponding top face of said tooth.

12. The reversible circular saw blade according to claim 11, wherein each said notch is angled steeper than the corresponding cutting edge in which the notch is defined, whereby the sharpened cutting tip of said corresponding cutting tip insert bonded to the notch extends beyond the corresponding cutting edge into the corresponding gullet.

13. The reversible circular saw blade according to claim 10, wherein each said notch is angled steeper than the corresponding cutting edge in which the notch is defined, whereby the sharpened cutting tip of said corresponding cutting tip insert bonded to the notch extends beyond the corresponding cutting edge into the corresponding gullet.
